(19) United States
(12) Patent Application Publication
(10) Pub. No.: US 2022/0098118 A1
(43) Pub. Date: Mar. 31, 2022

(54) NON-SINTERING METHOD FOR PREPARING ARTIFICIAL COBBLESTONE FROM DREDGED SOIL

(71) Applicant: TIANJIN UNIVERSITY OF SCIENCE AND TECHNOLOGY, TIANJIN (CN)

(72) Inventors: Yan WU, TIANJIN (CN); Xiao PENG, TIANJIN (CN); Na LI, TIANJIN (CN); Kairu XUE, TIANJIN (CN)

(21) Appl. No.: 17/643,821

(22) Filed: Dec. 10, 2021

Related U.S. Application Data
(63) Continuation of application No. PCT/CN2019/070169, filed on Jan. 3, 2019.

(30) Foreign Application Priority Data
Dec. 10, 2018 (CN) 201811504695.1

(51) Int. Cl. C04B 38/00

(52) U.S. Cl. CPC C04B 38/00; B24B 1/00

(57) ABSTRACT

Disclosed is a non-sintering method for preparing an artificial cobblestone from dredged soil, comprising the steps of: (1) preparing raw materials; (2) proportioning four types of materials; (3) preparing high-strength non-sintering ceramsite; (4) preparing a cobblestone core; (5) preparing a primary product of the cobblestone; (6) polishing; (7) curing; and (8) forming a finished product. In the method, the dredged soil is used as the raw material to prepare the artificial cobblestone with a core-shell structure, so that an application range of dredged soil recycling utilization can be widened, and a method for preparing artificial cobblestones is provided. By employing the non-sintering method for preparation, the energy consumption for production is low, and a decorative effect of the cobblestone can be achieved.

### CROSS-REFERENCE TO RELATED APPLICATIONS

This application is a continuation of International Patent Application No. PCT/CN2019/070169 with a filing date of Jan. 3, 2019, designating the United States, now pending, and further claims priority to Chinese Patent Application No. 201811504695.1 with a filing date of Dec. 10, 2018. The content of the aforementioned applications, including any intervening amendments thereto, are incorporated herein by reference.

### TECHNICAL FIELD

The present invention belongs to the dredging industry and the field of building material technologies, and relates to the environmental protection utilization of dredged sediment, and more particularly to a non-sintering method for preparing artificial cobblestones from dredged soil.

### BACKGROUND

All countries in the world, comprising China, carry out large-scale dredging and desilting every year, producing hundreds of millions of tons of dredged sediment. Therefore, the resource utilization of the dredged sediment has become an urgent problem to be solved.

At present, in a resource utilization direction of dewatering the dredged sediment to obtain dredged soil, the dredged soil is mainly used as a raw material for preparing a building material, preparing ceramsite by a sintering method is mostly studied, and the process is mature, and has been widely used in many building aggregates. The application of the dredged sediment to the building materials not only solves a problem of a large amount of sediment which is difficult to deal with, but also reduces the consumption of natural aggregates in the building industry, thus achieving great comprehensive social benefits of turning waste into wealth, saving energy and reducing emissions.

The sintering method is mostly used in the resource utilization of the dredged sediment in building materials at home and abroad, and the sintering method needs a lot of energy sources and consumes a lot of coal resources every year, which is unfavorable for cost control. Moreover, a lot of CO₂ is produced during sintering, which affects the environment.

The composition of the technology applied by the present invention mainly aims at the environmental protection technology of applying the dredged sediment to an artificial cobblestone. At present, the injection molding of unsaturated resin is mostly used in the method for preparing the artificial cobblestones, the method requires a high molding temperature, and the resin itself is expensive.

No patent publications related to the patent application of the present invention are found through searching.

### SUMMARY

The technical problem to be solved by the present invention is to provide a non-sintering method for preparing an artificial cobblestone from dredged soil, which is low in production energy consumption, does not undergo high-temperature curing, and has the same decorative effect as other artificial cobblestones.

The technical solutions used in the present invention to solve the technical problem are as follows.

A non-sintering method for preparing an artificial cobblestone from dredged soil comprises the steps of:

(1) preparing raw materials: sieving dredged soil, cement, mineral powder, coal ash, quicklime, phosphogypsum, silica powder and glass powder by using a 1 mm standard sieve, and taking materials smaller than 1 mm, with a moisture content less than 10%;

(2) proportioning four types of materials:

\textcircled{1} a non-sintering ceramsite-shell-coated material, consisting of the following materials in percentage by weight respectively: 15% to 25% of cement, 60% to 75% of mineral powder, 5% to 15% of coal ash, 1% to 5% of quicklime, 1% to 5% of phosphogypsum and 0.2% to 2.0% of fiber;

\textcircled{2} a cobblestone core shell layer material, consisting of the following materials in percentage by weight respectively: 20% to 30% of cement, 55% to 70% of mineral powder, 5% to 15% of coal ash, 1% to 5% of quicklime and 1% to 5% of phosphogypsum;

\textcircled{3} a cobblestone outer-shell layer material, consisting of the following materials in percentage by weight respectively: 50% to 70% of cement, 30% to 50% of glass powder, 0.2% to 1.0% of nano-SiO₂, and 0.2% to 0.5% of dispersible rubber powder; and

\textcircled{4} an additive, prepared by mixing two materials of white latex, water glass, sucrose and glycerin, with a proportioning method that: a weight ratio of the two materials is 1:2 to 1:10, and the two materials are evenly mixed with water according to 5% to 15% by mass, thus preparing the additive;

(3) preparing high-strength non-sintering ceramsite: preparing 10 mm to 20 mm cobblestones by non-sintering ceramsite gradations of 10% to 25% of 1 mm to 3 mm, 50% to 65% of 3 mm to 5 mm, and 15% to 30% of 5 mm to 8 mm; preparing 20 mm to 25 mm cobblestones by non-sintering ceramsite gradations of 5% to 15% of 1 mm to 3 mm, 15% to 35% of 3 mm to 5 mm, 55% to 70% of 5 mm to 8 mm, and 10% to 20% of 8 mm to 12 mm; preparing 25 mm to 35 mm cobblestones by non-sintering ceramsite gradations of 10% to 25% of 1 mm to 3 mm, 15% to 30% of 3 mm to 5 mm, 50% to 65% of 5 mm to 8 mm, and 10% to 25% of 8 mm to 12 mm; and spraying the additive above, and coating with the non-sintering ceramsite-shell-coated material above to prepare the high-strength non-sintering ceramsite;

(4) preparing a cobblestone core: on the basis of the coated high-strength non-sintering ceramsite, spraying the additive above, bonding first, and then coating with the cobblestone core shell layer material to prepare the cobblestone core;

(5) preparing a primary product of the cobblestone: on the basis of the prepared cobblestone core, spraying the additive, adding the cobblestone outer shell layer material for coating, thus forming the primary product of the cobblestone, spraying water, maintaining and drying in the air;

(6) polishing: roughly polishing the maintained primary product of the cobblestone by using an emery grinding head;

(7) curing: curing a polished surface of the cobblestone; and

(8) forming a finished product: drying in the air, thus forming the finished product of the cobblestone.

Moreover, the fiber in \textcircled{1} in the step (2) of proportioning the four types of materials comprises a carbon fiber and a glass fiber.

Moreover, the cobblestone outer shell layer material in \textcircled{3} in the step (2) of proportioning the four types of materials consists of the following materials in percentage by weight respectively: 50% to 70% of cement, 35% to 50% of silicon powder, 0.2% to 1% of nano-SiO₂ and 0.2% to 0.5% of dispersible rubber powder.

Moreover, the additive in \textcircled{4} in the step (2) of proportioning the four types of materials is formed by mixing three materials of white latex, water glass, sucrose and glycerin, with a proportioning method that: a weight ratio of the three materials is 1:1:8 to 2:3:5, and the three materials are evenly mixed with water according to 5% to 15% by mass, thus preparing the additive.

Moreover, the cobblestone is classified into an inorganic cobblestone and a composite cobblestone, for the inorganic cobblestone, in the step (6), the primary product of the cobblestone is roughly polished with 200-mesh and 600-mesh emery grinding heads respectively, a curing agent diluted by 5 times to 8 times is coated on a surface of the inorganic cobblestone, kept moist for one hour, and the surface of the cobblestone is finely polished with 300-mesh, 500-mesh, 800-mesh and 1,000-mesh emery papers; the curing agent is necessary to be used for secondary curing in the step (7); in the step (8), the cured cobblestone is necessary to be polished with a wool mat after drying in the air; and

for the composite cobblestone, in the step (7), an organic polyurea material is sprayed on the roughly polished surface of the cobblestone core with a thickness of 1 mm to 5 mm.

The present invention has the advantages and positive effects as follows:

1. The present invention is based on the dredged sediment high-strength shell-coating non-sintering ceramsite, the artificial cobblestone core is prepared as a skeleton of the artificial cobblestone by a bonding process, and the shell of the artificial cobblestone is made of inorganic and organic materials, so as to obtain the artificial cobblestone with the core-shell structure, which can not only widen an application range of dredged soil recycling utilization, but also provide a novel method for preparing the artificial cobblestones.

2. In the method, the material proportion and the process steps are controlled, the parameters are designed reasonably, the whole process is scientific and ingenious, and the operation is simple, without needing to sinter the artificial cobblestone, so that production energy consumption can be reduced, and a large amount of dredged soil is consumed, which meets a requirement of waste utilization, with a low production cost, so that needs of a building market are met.

3. According to the present invention, polypropylene fiber, carbon fiber and glass fiber are introduced into the cobblestone, which can effectively improve the strength of the non-sintering shell-coating ceramsite; the non-sintering shell-coating ceramsite is bonded through the additive, deformed and coated to form the cobblestone core, the shell layer of the non-sintering shell-coating ceramsite forms a network structure inside the cobblestone core, in which the dredged soil is filled, and the complete artificial cobblestone is prepared from an inorganic cementing material and an organic polyurea material on the surface of the cobblestone core, thus forming the artificial cobblestone with a compact internal structure, a good stability and a high strength.

4. According to the present invention, the inorganic cementing material and an organic elastomer material are respectively used to modify the surface of the cobblestone, thus providing two ways for the method for preparing the artificial cobblestones.

5. The surface of the inorganic artificial cobblestone prepared by the present invention is polished and cured to different degrees, so that the surface is smooth and gorgeous, with the same decorative and aesthetic effect as a natural cobblestone, and can be used in building materials instead of the natural cobblestone.

6. The surface of the composite artificial cobblestone prepared by the present invention is made of the organic elastomer material, which can improve a toughness of the cobblestone, and a compressive strength of the cobblestone can be further improved by changing the spraying thickness of the organic elastomer material.

### BRIEF DESCRIPTION OF THE DRAWINGS

FIG. 1 is a picture of a finished product of an inorganic artificial cobblestone of the present invention; and

FIG. 2 is a picture of a finished product of a composite artificial cobblestone of the present invention.

### DETAILED DESCRIPTION

The present invention is further described hereinafter with reference to the embodiments, and the following embodiments are descriptive and not restrictive, and cannot limit the scope of protection of the present invention.

It should be noted in advance that:

Unless otherwise specified, the raw materials used in the present invention are all conventional commercial products; and unless otherwise specified, the methods used in the present invention are all conventional methods in the art.

The dredged soil non-sintering shell-coating ceramsite used in the present invention is the dredged sediment non-sintering shell-coating ceramsite prepared by “a method for coating dredged sediment non-sintering ceramsite” (CN105130235B), and coal ash may be collected from fly ash produced by a coal-fired power plant, with a performance meeting the technical requirement of GB1596-91 “coal ash for cement and concrete”. Quicklime is common building quicklime, with a performance meeting the technical requirement of JC/T621-2009 “quicklime for silicate building products”. The cement used may be 42.5-grade ordinary Portland cement, and the fibers are all ordinary commercial fibers.

The process applied by the present invention is discussed by the following three embodiments (two embodiments of inorganic artificial cobblestone+one embodiment of composite artificial cobblestone):

### Embodiment 1

A non-sintering method for preparing an artificial inorganic cobblestone from dredged soil comprised the following steps.

(1) Raw materials were prepared: dredged soil, cement, mineral powder, coal ash, quicklime and phosphogypsum were all sieved by using a 1 mm standard sieve, and materials smaller than 1 mm were taken, with a moisture content less than 10%.

(2) Four types of materials were proportioned:

\textcircled{1} a non-sintering ceramsite-shell-coated material consisted of the following materials in percentage by weight respectively: 15% to 25% of cement, 60% to 75% of mineral powder, 5% to 15% of coal ash, 1% to 5% of quicklime, 1% to 5% of phosphogypsum and 0.5% to 1.0% of carbon fiber;

\textcircled{2} a cobblestone core shell layer material consisted of the following materials in percentage by weight respectively: 20% to 30% of cement, 55% to 70% of mineral powder, 5% to 15% of coal ash, 1% to 5% of quicklime and 1% to 5% of phosphogypsum;

\textcircled{3} a cobblestone outer-shell layer material consisted of the following materials in percentage by weight respectively: 50% to 70% of cement, 30% to 50% of glass powder, 0.2% to 1.0% of nano-SiO₂, and 0.2% to 0.5% of dispersible rubber powder; and

\textcircled{4} an additive was prepared by mixing white latex and water glass, with a proportioning method that: a weight ratio of the white latex and the water glass was 1:5 to 1:8, and the white latex and the water glass were evenly mixed with water according to 5% to 15% by mass, thus preparing the additive.

(3) High-strength non-sintering ceramsite was prepared: 10 mm to 20 mm cobblestones were prepared by non-sintering ceramsite gradations of 10% to 25% of 1 mm to 3 mm, 50% to 65% of 3 mm to 5 mm, and 15% to 30% of 5 mm to 8 mm, the additive above was sprayed, and the non-sintering ceramsite-shell-coated material above was coated to prepare the high-strength non-sintering ceramsite.

(4) A cobblestone core was prepared: on the basis of the coated high-strength non-sintering ceramsite, the additive above was sprayed, bonding was performed first, and then the cobblestone core shell layer material was coated to prepare the cobblestone core.

(5) A primary product of the cobblestone was prepared: on the basis of the prepared cobblestone core, the additive was sprayed, the cobblestone outer shell layer material was added for coating to obtain the primary product of the cobblestone, and the primary product of the cobblestone was sprayed with water, maintained for 7 days and dried in the air.

Preparations of a core and a shell of the primary product of the inorganic cobblestone were a continuous process, and completed in a round pot granulator, that was, on the basis of the newly prepared cobblestone core, the cobblestone outer-shell layer material was added, and the additive was sprayed for coating to obtain the core and the shell.

(6) Rough polishing and fine polishing were performed: the primary product of the cobblestone was roughly polished with 200-mesh and 600-mesh emery grinding heads respectively, a curing agent diluted by 5 times to 8 times was coated on a surface of the cobblestone, and kept moist for one hour, and the surface of the cobblestone was finely polished with 300-mesh, 500-mesh, 800-mesh and 1,000-mesh emery papers.

(7) Curing was performed: the finely polished surface of the cobblestone was cured again with the curing agent.

(8) A finished product was formed: the cured cobblestone was polished with a wool mat, thus preparing the finished product of the inorganic cobblestone.

### Embodiment 2

A non-sintering method for preparing an artificial inorganic cobblestone from dredged soil comprised the following steps.

(1) Raw materials were prepared: dredged soil, cement, mineral powder, coal ash, quicklime and phosphogypsum were all sieved by using a 1 mm standard sieve, and materials smaller than 1 mm were taken, with a moisture content less than 10%.

(2) Four types of materials were proportioned:

\textcircled{1} a non-sintering ceramsite-shell-coated material consisted of the following materials in percentage by weight respectively: 15% to 25% of cement, 60% to 75% of mineral powder, 5% to 15% of coal ash, 1% to 5% of quicklime, 1% to 5% of phosphogypsum and 0.2% to 0.5% of glass fiber.

\textcircled{2} a cobblestone core shell layer material consisted of the following materials in percentage by weight respectively: 20% to 30% of cement, 55% to 70% of mineral powder, 5% to 15% of coal ash, 1% to 5% of quicklime and 1% to 5% of phosphogypsum;

\textcircled{3} a cobblestone outer-shell layer material consisted of the following materials in percentage by weight respectively: 50% to 70% of cement, 30% to 50% of glass powder, 0.2% to 1.0% of nano-SiO₂, and 0.2% to 0.5% of dispersible rubber powder; and

\textcircled{4} an additive was prepared by mixing sucrose and water glass, with a proportioning method that: a weight ratio of the sucrose and the water glass was 1:5 to 1:10, and the sucrose and the water glass were evenly mixed with water according to 10% to 20% by mass, thus preparing the additive.

(3) High-strength non-sintering ceramsite was prepared: 20 mm to 25 mm cobblestones were prepared by non-sintering ceramsite gradations of 5% to 15% of 1 mm to 3 mm, 15% to 35% of 3 mm to 5 mm, 55% to 70% of 5 mm to 8 mm, and 10% to 20% of 8 mm to 12 mm, the additive above was sprayed, and the non-sintering ceramsite-shell-coated material above was coated to prepare the high-strength non-sintering ceramsite.

The non-sintering ceramsite gradations were 5% to 15% of 1 mm to 3 mm, 15% to 35% of 3 mm to 5 mm, 55% to 70% of 5 mm to 8 mm, and 10% to 20% of 8 mm to 12 mm, the additive above was sprayed, and the non-sintering ceramsite-shell-coated material above was coated to prepare the 20 mm to 25 mm high-strength non-sintering ceramsite.

(4) A cobblestone core was prepared: on the basis of the coated high-strength non-sintering ceramsite, the additive above was sprayed, bonding was performed first, and then the cobblestone core shell layer material was coated to prepare the cobblestone core.

(5) A primary product of the cobblestone was prepared: on the basis of the prepared cobblestone core, the additive was sprayed, the cobblestone outer shell layer material was added for coating to form the primary product of the cobblestone, and the primary product of the cobblestone was sprayed with water, maintained for 7 days and dried in the air.

Preparations of a core and a shell of the primary product of the inorganic cobblestone were a continuous process, and completed in a round pot granulator, that was, on the basis of the newly prepared cobblestone core, the cobblestone outer-shell layer material was added, and the additive was sprayed for coating to obtain the core and the shell.

(6) Rough polishing and fine polishing were performed: the primary product of the cobblestone was roughly polished with 200-mesh and 600-mesh emery grinding heads respectively, a curing agent diluted by 5 times to 8 times was coated on a surface of the cobblestone, and kept moist for one hour, and the surface of the cobblestone was finely polished with 300-mesh, 500-mesh, 800-mesh and 1,000-mesh emery papers.

(7) Curing was performed: the finely polished surface of the cobblestone was cured again with the curing agent.

(8) A finished product was formed: the cured cobblestone was polished with a wool mat, thus preparing the finished product of the inorganic cobblestone.

### Embodiment 3

A non-sintering method for preparing an artificial composite cobblestone from dredged soil comprised the following steps.

(1) Raw materials were prepared: dredged soil, cement, mineral powder, coal ash, quicklime and phosphogypsum were all sieved by using a 1 mm standard sieve, and materials smaller than 1 mm were taken, with a moisture content less than 10%.

(2) Four types of materials were proportioned:

\textcircled{1} a non-sintering ceramsite-shell-coated material consisted of the following materials in percentage by weight respectively: 15% to 25% of cement, 60% to 75% of mineral powder, 5% to 15% of coal ash, 1% to 5% of quicklime, 1% to 5% of phosphogypsum and 0.5% to 1.0% of carbon fiber;

\textcircled{2} a cobblestone core shell layer material consisted of the following materials in percentage by weight respectively: 20% to 30% of cement, 55% to 70% of mineral powder, 5% to 15% of coal ash, 1% to 5% of quicklime and 1% to 5% of phosphogypsum;

\textcircled{3} a cobblestone outer-shell layer material consisted of the following materials in percentage by weight respectively: 50% to 70% of cement, 30% to 50% of glass powder, 0.2% to 1.0% of nano-SiO₂, and 0.2% to 0.5% of dispersible rubber powder; and

\textcircled{4} an additive was prepared by mixing sucrose and water glass, with a proportioning method that: a weight ratio of the sucrose and the water glass was 1:5 to 1:10, and the sucrose and the water glass were evenly mixed with water according to 5% to 15% by mass, thus preparing the additive.

(3) High-strength non-sintering ceramsite was prepared: 25 mm to 35 mm cobblestones were prepared by non-sintering ceramsite gradations of 10% to 25% of 1 mm to 3 mm, 15% to 30% of 3 mm to 5 mm, 50% to 65% of 5 mm to 8 mm, and 10% to 25% of 8 mm to 12 mm, the additive above was sprayed, and the non-sintering ceramsite-shell-coated material above was coated to prepare the high-strength non-sintering ceramsite.

(4) A cobblestone core was prepared: on the basis of the coated high-strength non-sintering ceramsite, the additive above was sprayed, bonding was performed first, and then the cobblestone core shell layer material was coated to prepare the cobblestone core.

(5) Maintenance was performed: the prepared cobblestone core was sprayed with water, maintained for 7 days and dried in the air.

(6) Polishing was performed: the maintained cobblestone core was roughly polished with 200-mesh and 600-mesh emery grinding heads respectively.

(7) Spraying was performed: an organic polyurea material was sprayed on the roughly polished surface of the cobblestone core with a thickness of 1 mm to 5 mm.

(8) A finished product was formed: the cobblestone was dried in the air for 1 day to 3 days, thus forming the finished product of the composite artificial cobblestone.

Through inspection, performances of the dredged soil artificial cobblestones obtained in the embodiment are as follows.

1. Appearance:

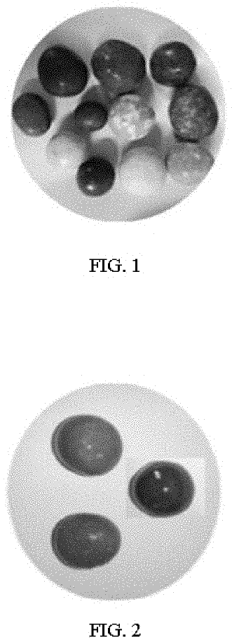

FIG. 1 is a picture of an entity of the inorganic artificial cobblestone; and

FIG. 2 is a picture of an entity of the composite artificial cobblestone.

2. Performance

| | | Water | Single | Compression |
|---|---|---|---|---|
| | Density/ | absorption/ | strength/ | strength/ |
| Name | (g · cm³) | % | MPa | MPa |
| Inorganic | 1.550 to 1.750 | 1% to 2% | 2.5 to 3.5 | — |
| artificial | | | | |
| cobblestone | | | | |
| Composite | 1.500 to 1.700 | 0% to 1% | — | 3.0 to 4.0 |
| artificial | | | | |
| cobblestone | | | | |

wherein: the compression strength of the composite dredged soil artificial cobblestone is a maximum pressure when the cobblestone is deformed by 50%.

1. A non-sintering method for preparing an artificial cobblestone from dredged soil, comprising the steps of:
(1) preparing raw materials: sieving dredged soil, cement, mineral powder, coal ash, quicklime, phosphogypsum, silica powder and glass powder by using a 1 mm standard sieve, and taking materials smaller than 1 mm, with a moisture content less than 10%;
(2) proportioning four types of materials:
\textcircled{1} a non-sintering ceramsite-shell-coated material, consisting of the following materials in percentage by weight respectively: 15% to 25% of cement, 60% to 75% of mineral powder, 5% to 15% of coal ash, 1% to 5% of quicklime, 1% to 5% of phosphogypsum and 0.2% to 2.0% of fiber;
\textcircled{2} a cobblestone core shell layer material, consisting of the following materials in percentage by weight respectively: 20% to 30% of cement, 55% to 70% of mineral powder, 5% to 15% of coal ash, 1% to 5% of quicklime and 1% to 5% of phosphogypsum;
\textcircled{3} a cobblestone outer-shell layer material, consisting of the following materials in percentage by weight respectively: 50% to 70% of cement, 30% to 50% of glass powder, 0.2% to 1.0% of nano-SiO₂, and 0.2% to 0.5% of dispersible rubber powder; and
\textcircled{4} an additive, prepared by mixing two materials of white latex, water glass, sucrose and glycerin, with a proportioning method that: a weight ratio of the two materials is 1:2 to 1:10, and the two materials are evenly mixed with water according to 5% to 15% by mass, thus preparing the additive;
(3) preparing high-strength non-sintering ceramsite: preparing 10 mm to 20 mm cobblestones by non-sintering ceramsite gradations of 10% to 25% of 1 mm to 3 mm, 50% to 65% of 3 mm to 5 mm, and 15% to 30% of 5 mm to 8 mm; preparing 20 mm to 25 mm cobblestones by non-sintering ceramsite gradations of 5% to 15% of 1 mm to 3 mm, 15% to 35% of 3 mm to 5 mm, 55% to 70% of 5 mm to 8 mm, and 10% to 20% of 8 mm to 12 mm; preparing 25 mm to 35 mm cobblestones by non-sintering ceramsite gradations of 10% to 25% of 1 mm to 3 mm, 15% to 30% of 3 mm to 5 mm, 50% to 65% of 5 mm to 8 mm, and 10% to 25% of 8 mm to 12 mm; and spraying the additive above, and coating with the non-sintering ceramsite-shell-coated material above to prepare the high-strength non-sintering ceramsite;
(4) preparing a cobblestone core: on the basis of the coated high-strength non-sintering ceramsite, spraying the additive above, bonding first, and then coating with the cobblestone core shell layer material to prepare the cobblestone core;
(5) preparing a primary product of the cobblestone: on the basis of the prepared cobblestone core, spraying the additive, adding the cobblestone outer shell layer material for coating, thus forming the primary product of the cobblestone, spraying water, maintaining and drying in the air;
(6) polishing: roughly polishing the maintained primary product of the cobblestone by using an emery grinding head;
(7) curing: curing a polished surface of the cobblestone; and
(8) forming a finished product: drying in the air, thus forming the finished product of the cobblestone.

2. The non-sintering method for preparing the artificial cobblestone from dredged soil according to claim 1, wherein the fiber in \textcircled{1} in the step (2) of proportioning the four types of materials comprises a carbon fiber and a glass fiber.

3. The non-sintering method for preparing the artificial cobblestone from dredged soil according to claim 1, wherein the cobblestone outer shell layer material in \textcircled{3} in the step (2) of proportioning the four types of materials consists of the following materials in percentage by weight respectively: 50% to 70% of cement, 35% to 50% of silicon powder, 0.2% to 1% of nano-SiO₂ and 0.2% to 0.5% of dispersible rubber powder.

4. The non-sintering method for preparing the artificial cobblestone from dredged soil according to claim 1, wherein the additive in \textcircled{4} in the step (2) of proportioning the four types of materials is formed by mixing three materials of white latex, water glass, sucrose and glycerin, with a proportioning method that: a weight ratio of the three materials is 1:1:8 to 2:3:5, and the three materials are evenly mixed with water according to 5% to 15% by mass, thus preparing the additive.

5. The non-sintering method for preparing the artificial cobblestone from dredged soil according to claim 1, wherein the cobblestone is classified into an inorganic cobblestone and a composite cobblestone, for the inorganic cobblestone, in the step (6), the primary product of the cobblestone is roughly polished with 200-mesh and 600-mesh emery grinding heads respectively, a curing agent diluted by 5 times to 8 times is coated on a surface of the inorganic cobblestone, kept moist for one hour, and the surface of the cobblestone is finely polished with 300-mesh, 500-mesh, 800-mesh and 1,000-mesh emery papers; the curing agent is necessary to be used for secondary curing in the step (7); in the step (8), the cured cobblestone is necessary to be polished with a wool mat after drying in the air; and
for the composite cobblestone, in the step (7), an organic polyurea material is sprayed on the roughly polished surface of the cobblestone core with a thickness of 1 mm to 5 mm.
